(19) United States
(12) Patent Application Publication
(10) Pub. No.: US 2023/0095170 A1
(43) Pub. Date: Mar. 30, 2023

(54) BONDED SAND OBJECTS

(71) Applicant: Bar COHEN, Ramat Gan (IL)

(72) Inventor: Bar COHEN, Ramat Gan (IL)

(21) Appl. No.: 17/991,951

(22) Filed: Nov. 22, 2022

Related U.S. Application Data
(63) Continuation of application No. PCT/IB2021/055348, filed on Jun. 17, 2021.
(60) Provisional application No. 63/041,139, filed on Jun. 19, 2020.

(51) Int. Cl. B44C 3/06; A63H 33/32; A63H 33/00

(52) U.S. Cl. CPC B44C 3/06; A63H 33/001; A63H 33/32

(57) ABSTRACT

Objects made of waterglass-bonded sand, methods of making such objects and kits useful for making such objects. In some embodiments, an object according to the teachings herein is a final goods (as opposed to being an intermediate goods) such as a toy, a medallion, a building block, furniture, a wall, a portion of a sand castle and a sand castle.

### RELATED APPLICATION

The present application gains priority from U.S. Provisional Pat. Application 63/041,139 filed 19 Jun. 2020, which is included by reference as if fully set-forth herein.

### FIELD AND BACKGROUND OF THE INVENTION

The invention, in some embodiments, relates to the field of manufacture and, more particularly but not exclusively, to objects made of bonded sand, methods of making such objects and kits useful for making such objects.

People going to the beach often take plastic objects with them for use on the beach, for example, beach toys.

Often, the plastic objects are intentionally or unintentionally left at the beach. Beach operators incur a significant expense in having to remove the plastic objects from the beach. Even worse, the plastic objects may remain on the beach or be washed into the sea, thereby causing pollution.

It would be useful to have objects that can be used in places such as beaches that, even if discarded, do not constitute pollution.

### SUMMARY OF THE INVENTION

Some embodiments of the invention herein relate to objects, such as toys, made of bonded sand, methods of making such objects and kits useful for making such objects that can be used in places like beaches.

According to an aspect of some embodiments of the invention, there is provided an object made of waterglass-bonded sand, the object being a final goods.

In some embodiments, the object comprises not less than 50% by weight waterglass-bonded sand.

In some embodiments, the sand in the waterglass-bonded sand is beach sand.

In some embodiments, the object is selected from the group consisting of a toy, a medallion, a building block, furniture, a wall, a portion of a sand castle and a sand castle.

In some embodiments, the object is a toy. In some such embodiments, the object weighs not more than 1000 g. In some such embodiments, the object is a toy selected from the group consisting of a human figure, an animal figure, a vehicle figure, a container, a digging implement, and a toy building block.

In some embodiments, the object is a medallion. In some such embodiments, the object weighs not more than 400 g.

In some embodiments, the object is a building block selected from the group consisting of a brick, a block, a building frame, a shingle, and a roofing tile.

In some embodiments, the object is furniture, in some such embodiments selected from the group consisting of a beach chair, a bench, a lounger, a stool, a table and a bar.

In some embodments, the object is a scented object.

According to an aspect of some embodiments of the invention, there is also provided a method for making an object, comprising:
a. providing a moldable composition including a combination of sand and waterglass;
b. fashioning the moldable composition into the shape of an object that is a final goods;
c. contacting the shaped moldable composition with an amount of weak acid and for a duration sufficient to change the shaped moldable composition to waterglass-bonded sand having the shape of the object, thereby making the object

According to an aspect of some embodiments of the invention, there is also provided a method for making an object, comprising:
a. providing a moldable composition including a combination of sand and waterglass,
b. fashioning the moldable composition into the shape of an object according to the invention as described herein;
c. contacting the shaped moldable composition with an amount of weak acid and for a duration sufficient to change the shaped moldable composition to waterglass-bonded sand having the shape of the object, thereby making the object.

In some embodiments, the providing a moldable composition includes: harvesting sand from a beach; and combining the harvested sand with waterglass, and optionally with at least one additional material, thereby providing the moldable composition.

In some embodiments, combining the harvested sand with the waterglass is is performed at a beach, preferably the beach where the sand was harvested.

In some embodiments, the fashioning of the moldable composition into the shape of an object is performed at a beach, preferably the beach where the sand was harvested.

In some embodiments, the contacting of the shaped moldable composition with an amount of weak acid is performed at a beach, preferably the beach where the sand was harvested.

In some embodiments, the sand is unrinsed sand.

In some embodiments, the fashioning is performed using a technique selected from the group consisting of molding the moldable composition, piling the moldable composition, sculpting the moldable composition and a combination thereof.

In some embodiments, the contacting a weak acid with the shaped moldable composition comprises contacting CO₂ with the shaped moldable composition. In some such embodiments, the CO₂ is gaseous CO₂.

In some embodiments, the contacting gaseous CO₂ with the shaped moldable composition comprises at least one method selected from the group consisting of: injecting carbon dioxide into the shaped moldable composition from a carbon dioxide reservoir; immersing the shaped moldable composition in a carbon dioxide enriched atmosphere; applying gaseous carbon dioxide to the shaped moldable composition from the top thereof; and placing dry ice on the shaped moldable composition.

In some embodiments, any of the methods further comprises adding a scent material to the moldable composition, to the shaped moldable composition and/or to the waterglass-bonded sand, so that the object is a scented object

According to an aspect of some embodiments of the invention, there is also provided a kit for implementing any of the methods described herein.

### BRIEF DESCRIPTION OF THE FIGURE

Some embodiments of the invention are described herein with reference to the accompanying figure. The description, together with the figure, makes apparent to a person having ordinary skill in the art how some embodiments of the invention may be practiced. the figure are for the purpose of illustrative discussion and no attempt is made to show structural details of an embodiment in more detail than is necessary for a fundamental understanding of the invention. For the sake of clarity, some objects depicted in the figures are not to scale.

In the Figure:

FIG. 1 is a reproduction of a photograph showing stages of enviromentally-friendly disintegration of objects in accordance with the teachings herein.

### DESCRIPTION OF SOME EMBODIMENTS OF THE INVENTION

Some embodiments of the invention herein relate to objects made of bonded sand, methods of making such objects and kits useful for making such objects that can be used in places like beaches.

The principles, uses and implementations of the teachings of the invention may be better understood with reference to the accompanying description and figures. Upon perusal of the description and figures present herein, one skilled in the art is able to implement the teachings of the invention without undue effort or experimentation. In the figures, like reference numerals refer to like parts throughout.

Before explaining at least one embodiment of the invention in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

### Object According to the Teachings Herein

In some embodiments, an object according to the teachings herein is an object made by an embodiment of the method according to the teachings herein, as described herein.

An object according to the teachings herein is made of waterglass-bonded sand.

Sand is a well-known granular material comprising small particles of rock and mineral particles, primarily silicon dioxide and calcium carbonate.

Waterglass is a common name for a syrupy sodium silicate solution (CAS Nr. 1344-09-08) that contains sodium dioxide and silica in water. Waterglass is widely used in industry and is available from many commercial suppliers,

In the art, it is well-known to combine sand and waterglass to make a moldable composition (similar in consistency and properties to wet sand). The addition of a weak acid to the composition causes the waterglass to bind the sand together to make a hard rock like substance, herein called waterglass-bonded sand. waterglass-bonded sand is well known in the art for use in making molds that are suitable, for example, for manufacture of metal objects from molten metal.

The Inventor has discovered, developed and now discloses the use of waterglass-bonded sand for the manufacture of objects that are final goods. As known in the art, final goods are objects used by a consumer to satisfy a wants or need. In contrast, intermediate goods are objects used as tools to produce other goods, such as molds.

In preferred embodiments, the objects are made and used at a sandy beach. The sand provides the primary raw material for making the object from waterglass-bonded sand. After the object is used, the object is discarded on the beach and disintegrates to nothing by the action of wind and water at the beach. The teachings herein not only provide an environmentally-friendly substitute for objects typically used and discarded at beaches, but also teach a critical lesson in sustainability and care for the environment.

### Object

Thus, according to an aspect of some embodiments of the teachings herein there is provided an object made of waterglass-bonded sand, the object being a final goods.

### Composition of the Object

In some embodiments, the object is made of a different material in addition to waterglass-bonded sand, e.g., at least one rock, pebble, sea shell, piece of wood, piece of metal, glass but, in preferred embodiments, the object comprises not less than 50%, not less than 60%, not less than 70%, not less than 80% and even not less than 90% by weight waterglass-bonded sand. In some embodiments, the object comprises not less than 95% and even not less than 98% by weight waterglass-bonded sand. In some alternative embodiments, the object comprises not more than 95% and even not more than 90% by weight waterglass-bonded sand.

The waterglass-bonded sand portion of the object is made of any composition of waterglass-bonded sand as known in the art.

The sand is any suitable type of sand. As used herein, the average diameter of grains of sand used for implementing the teachings herein is from 0.0625 mm (a volume of ~0.00012 cubic millimeters) to 2 mm (a volume of ~4.2 cubic millimeters). In preferred embodiments, the sand is beach sand, in some embodiments which sand includes sea shell fragments (made of calcium carbonate and/or citin, from any organism especially molluscs, brachiopods, crustaceans, horseshoe crabs and / or sea urchins) . In some embodiments, the sand is unwashed sad, i e, includes salts from a body of water near where the sand was harvested, such as the sea.

Any waterglass that is suitable for making waterglass-bonded sand is suitable for implementing the teachings herein . In some embodiments, the waterglass is made up of a water solution of chemical compounds with the formula Na₂ₓSiO₂₊ₓ or (Na₂O)ₓ·SiO₂, such as sodium metasilicate Na₂SiO₃, sodium orthosilicate Na₄SiO₄, and sodium pyrosilicate Na₆Si₂O₇, where x is any integer. In some embodiments, the waterglass is (NaOH)ₓ(Na₂SiO₂)_{y} . z H₂O, where x, y and z are anysuitable integer, in some embodiments comprising Na₂O and SiO₂, e.g., 8-15% w/w Na₂O and 20%-30% w/w/ SiO₂.

Any type of weak acid known for initiating waterglass bonding of sand may be used In preferred embodiments, the weak acid used to initiate the bonding of the sand is the result of gaseous carbon dioxide added to water in a waterglass / sand composition.

### Types of Object

The object is any suitable object that is a final goods, in preferred embodiments selected from the group consisting of a toy, a medallion, a building block, furniture, a wall, a portion of a sand castle and a sand castle.

In some embodiments the object is toy. In some such embodiments, the object is relatively light allowing for easy play. Accordingly, in some embodiments, the object is a toy weighing not more than 1000 g, not more than 800 g, nor more than 600 g, not more than 400 g and even not more than 200 g. In some embodiments when the object is the toy, the toy is selected from the group consisting of a human figure (e.g., a doll), an animal figure, a vehicle figure, a container such as a bucket or box, a digging implement such as a spade and a toy building block (e.g., analogous, similar or identical to Megablocks® or Lego®).

In some embodiments the object is a medallion. In some such embodiments, the object is relatively light. Accordingly, in some embodiments, the object is a medallion weighing not more than 400 g, not more than 200 g, not more than 100 g and even not more than 50 g.

In some embodiments when the object is a building block, the object allows for construction of a temporary structure or shelter, In some embodiments, the building block is selected from the group consisting of a brick, a block (i.e., a construction masonry unit, CMU), a building frame, a shingle, and a roofing tile.

In some embodiments the object is furniture. In some such embodiments, the object is beach furniture. In some embodiments, the object is furniture selected from the group consisting of a beach chair, a bench, a lounger, a stool, a table and a bar. Such embodiments allow making temporary furniture, e.g., on a beach, e.g, for a party or restaurant.

In some embodiments when the object is a wall, the object allows for temporary separation of different parts of a beach, for example for a beach party. In some embodiments the object is a wall that is made in situ In some alternative embodiments, the object is a wall made of objects of the invention that are building blocks as described above.

In preferred embodiments, after being made, the object is durable for a period of a few hours, even when wet (e.g., from contact with water from waves) and/or played with. In preferred embodiments, after more than a few hours exposed to water such as on a beach, the object disintegrates without a trace and in an environmentally friendly fashion, e.g., by the action of wind and/or waves.

### Method According to the Teachings Herein

An object according to the teachings herein is made of waterglass-bonded sand as detailed above . Any suitable composition for making waterglass-bonded sand may be used for making an object of the teachings herein, for example, as known in the art Any suitable method for making waterglass-bonded sand objects may be used for making an object of the teachings herein, for example, as known in the art

According to an aspect of some embodiments of the teachings herein, there is provided a method for making an object, especially an object according to the teachings herein, comprising.
a. providing a moldable composition including a combination of sand and waterglass,
b. fashioning the moldable composition into the shape of an object that is a final goods;
c. contacting the shaped moldable composition with an amount of weak acid and for a duration sufficient to change the shaped moldable composition to waterglass-bonded sand (i.e., solidifying the fashioned moldable composition) having the shape of the obj ect,
thereby making the object.

The shape is any suitable shape and the object is any suitable object that is a final goods. In some preferred embodiments, the object is an object according to the teachings herein, as described herein.

### Providing the Composition

Providing the composition including a combination of sand and waterglass is done in any suitable way. In some embodiments, the providing comprises combining (mixing) sand and waterglass. In some embodiments, the providing comprises combining sand and waterglass and also at least one additional different material, e.g., as described above. In some embodiments, the providing comprises first harvesting sand from a beach, and then combining the sand with the waterglass. In some preferred embodiments, harvested sand is not cleaned. In some preferred embodiments, the sand is unrinsed sand (i.e., not washed or rinsed with fresh water), so that the sand includes salts from a body of water near where the sand was harvested, such as the sea. In preferred embodiments, the combining of sand with waterglass is performed in situ at the location where the sand is harvested, such as a beach.

In some embodiments, the fashioning and contacing take place on a beach.

The provided composition is any suitable composition that includes sand, waterglass and optionally at least one additional material. Corresponding to the noted above, in preferred embodiments, the provided composition comprises not less than 50%, not less than 60%, not less than 70%, not less than 80% and even not less than 90% by weight sand and waterglass. In some embodiments, the provided composition comprises not less than 95% and even not less than 98% by weight sand and waterglass. In some alternative embodiments, the provided composition comprises not more than 95% and even not more than 90% by weight sand and waterglass.

The proportion of sand to waterglass in the provided composition is any suitable proportion, for example, as known in the art of waterglass-bonded sanded. It has been found that from about 3 parts waterglass to 100 parts sand (w/w) in the provided composition, the resulting bonded object become progressively more durable with increased waterglass content. It has been found that when there are more than about 10 parts waterglass to about 100 parts sand (w/w) in the provided composition, the resulting bonded object is very durable but expensive due to the very high waterglass content. Accordingly In preferred embodiments, the provided composition comprises between about 3 parts and about 10 parts waterglass for every 100 parts sand (w/w). In some preferred embodiments, the provided composition comprises between about 5 parts and about 7 parts waterglass for every 100 parts sand (w/w), e.g., about 6 parts waterglass for every 100 parts sand (w/w), a composition that was found to yield an object that loses all structural integrity only after between 7 and 8 hours immersion in sea water, so is thereby sufficiently durable for typical purposes of the teachings hereinand uses an economical amount of waterglass.

In preferred embodiments, the moldable composition and the shaped moldable composition are not heated above ambient temperature.

### Fashioning an Object

A desired object is fashioned from the moldable composition in the usual way into the shape of an object that is the desired final goods, e.g., as described above. Fashioning is performed in any suitable way using any suitable technique or combination of techniques.

In some embodiments, the object is fashioned by placing the moldable composition in a mold. In some embodiments, the mold is a two-part mold. In some embodiments, the mold is a one-part mold. The mold is of any suitable material or combination of materials, e.g., wood, aluminum and silicone rubber. Importantly, after the moldable composition is changed into waterglass-bonded sand, the object is preferably removed from the mold.

Additionally or alternatively, in some embodiments, the object is fashioned by piling of the moldable composition to make a pile of moldable composition.

Additionally or alternatively, in some embodiments, the object is fashioned by sculpting (e.g., as known in the art of sand sculpting). In some embodiments, the sculpting is of a pile of moldable composition.

### Solidifying the Object

As noted above, the moldable composition fashioned into the shape of the object is contacted with a weak acid in an amount of acid and for a duration sufficient to change the moldable composition to waterglass-bonded sand. As noted above, any type of weak acid known for initiating waterglass bonding of sand may be contacted with the shaped moldable composition. In preferred embodiments, the contacting comprises contacting CO₂ with the shaped moldable composition, so that the CO₂ dissolves in water of the composition to form a weak acid. Preferably, the amount of carbon dioxide applied is such to fill all of the fashioned moldable composition so that entire composition is contacted with a weak acid and changes to waterglass-bonded sand, even the the internal portions.

In preferred embodiments, the carbon dioxide is applied as gaseous CO₂.

In some embodiments, carbon dioxide is injected into the shaped moldable composition, e.g., with a needle from a carbon dioxide reservoir.

Additionally or alternatively, in some embodiments, the shaped moldable composition is immersed in a carbon dioxide enriched atmosphere, eg., placed in a vessel filled with carbon dioxide gas.

Additionally or alternatively, in some embodiments, carbon dioxide is applied (e.g., by pouring) onto the shaped moldable composition from the top so that the carbon dioxide settles into the shaped moldable composition.

Additionally or alternatively, in some embodiments, dry ice is placed on a shaped moldable composition so that gaseous carbon dioxide from the dry ice settles into the shaped moldable composition.

### Durability of the Object

Generally, as long as an object of the teachings herein is dry, it is durable, roughly like an equivalent sandstone object.

When wet with water, an object does not immediately lose structural integrity and if allowed to dry regains the original durability. In some embodiments, an object according to the teachings herein does not lose substantial structural integrity when immersed for less than 15 minutes in sea water, e.g., Mediterranean Sea water. In some embodiments, an object according to the teachings herein does not lose substantial structural integrity when immersed for less than 30 minutes in sea water and even when immersed for less than 60 minutes in sea water.

As used herein “does not lose structural integrity” means that the object does not break when dropped from 1 meter height onto a flat wet sand surface, such as found on the shoreline of a sandy beach.

However, when wet by water for a substantial time, an object loses its structural integrity relatively quickly and disintegrates into sand in an environmentally-friendly fashion.

The rate of loss of structural integrity depends, inter alia, on the salinity of the water (losing structural integrity faster in fresh water than in salt water) and the proportion of waterglass to sand in the composition used to make the object (less waterglass in the object leads to faster loss of structural integrity). For example, a preferred object was made and found to lose all structural integrity after between 7 and 8 hours immersion in Mediterranean Sea water. An identical object lost all structural integrity after 1 hour immersion in fresh water. In some embodiments, an object according to the teachings herein loses all structural integrity subsequent to not more than 24 hours immersion in sea water, e.g., Mediterranean Sea water. That said, in some embodiments, an object according to the teachings herein loses all structural integrity subsequent to not more than 12 hours, not more than 10 hours and even not more than 8 hours immersion in sea water.

As used herein “loses all structural integrity” means that the object is weakened to the point that a normal adult human can use their hands without any tools to press the object apart into sand (e.g., knead) and not leave any lumps.

### Scent

In some embodiments, an object according to the teachings herein is scented, that is to say, includes a scent material other than waterglass and sand that provides a scent perceivable by a normal human having a normal sense of smell. In some embodiments, the method further comprises: adding a scent material so that the object is a scented object.

In some embodiments, the method further comprises at least one member of the group consisting of:
wherein the provided moldable composition includes a scent material;
adding a scent material to the moldable composition prior to or during the fashioning;
adding a scent material to the shaped moldable compostion after the fashioning and prior to the contacting with the weak acid;
adding a scent material to the shaped moldable compostion concurrently and/or simultaneously with the contacting with the weak acid; and
adding a scent material to the waterglass-bonded sand object.

In some embodiments, the scent material is a perfume and/or a perfume component. In some such embodiments, the scent material comprises or consists an essential oil, optionally in a carrier. Typical scent materials include a scent material selected from the group consisting of allspice oil; ambrette oil; anise oil, basil oil, bergamot oil; black pepper oil; borneol oil; cajeput oil; calamintha oil; camphor white oil; carrot seed oil; cedarwood oil; chamomile oil; cinnamon oil; citrodora oil; citronella oil; citrus oil, clary sage oil; coriander oil; cypress oil; elemi oil; eucalyptus oil; fennel oil; frankincense oil; galbenum oil; geranium oil; ginger oil, grapefruit oil; helichrysum oil; hemlock oil; hyssop oil, jasmine oil; lavender oil; lavendin oil; lemon oil; lemon balm oil; lemongrass oil; lime oil; mandarin oil; marjoram oil; mastic oil; mint oil; myrrh oil; niaouli oil; neroli oil; nutmeg oil: orange oil; palmarosa oil; patchouli oil; peppermint oil; petitgrain oil; pine oil; rose oil; rosemary oil; sage oil; sandalwood oil; silver fir oil; spearmint oil; spruce oil; star anise oil; thyme oil; turmeric oil; turpentine oil; vanilla oil; vetiver oil; wintergreen oil; and ylang ylang oil; and combinations thereof.

### Kit According to the Teachings Herein

A kit according to the teachings herein is a kit useful for carrying out the method according to the teachings herein, preferably in an outdoors location such as a beach.

In some embodiments, a kit includes a waterglass in a container, e.g., a plastic bottle or jug. Preferred soidum silicate solutions are as discussed above.

Additionally or alternately, in some embodiments a kit includes volumetric measuring vessels allowing a volume of sand to be measured and an appropriate volume of waterglass. For example, in some embodiments a kit comprises a first vessel for measuring a volume of sand and a second vessel for measuring a volume of waterglass equivalent to an amount of waterglass for implementing the teachings herein.

Additionally or alternately, in some embodiments a kit includes a carbon dioxide dispenser that includes:
a hollow injection needle having a distal end that is to be configured to be inserted into a mass of composition as described above allowing dispensing of carbon dioxide into the mass of composition; and
a controllable dispensing valve that allows release of carbon dioxide from a carbon dioxide reservoir physically associated with the dispensing valve and out of the hollow injection needle.

In some preferred embodiments, the injection needles is configured to be physically associated with a carbon dioxide reservoir with a flexible tube.

In some preferred embodiments, the carbon dioxide dispenser weighs not more than 2 kg, not more than 1 kg and even not more than 500 g.

Additionally or alternately, in some embodiments a kit includes a carbon dioxide reservoir.

In some preferred embodiments, the carbon dioxide dispenser together with a physically-associated carbon dioxide reservoir weighs not more than 10 kg, not more than 5 kg, not more than 2 kg and even not more than 1.5 kg.

### Experimental

### Making a Mold

A standard 3D printer was used to print a model of a stylized cat from polylactic acid The model was 15 cm tall and had a greatest diameter of 10 cm. The model had decorative elements that were configured to function as sand-stamps.

A square outer mold of fiberglass defining an internal cavity of 30 cm width by 30 cm breadth by 20 cm depth was partially filled with a fluid silicone rubber composition. A first half of the model was covered with a protective layer of modeling clay. The second half of the model was sprayed with mold-release agent and then immersed in the fluid silicone rubber composition in the outer mold and maintained therein until the fluid silicone rubber composition solidified, thereby forming a second piece of an inner mold.

The clay was removed from the first half of the model while the model was maintained in the second piece of the inner mold. The periperal faces of the second piece of the inner mold as well as the exposed first half of the model were sprayed with mold release agent. The square outer mold of fiberglass was partially filled with a fluid silicone rubber composition and the second piece of the mold pushed to contact the fluid silicone rubber composition so that the first half of the model was immersed in the fluid silicone rubber composition in the outer mold and maintained therein until the fluid silicone rubber composition solidified, thereby forming a first piece of an inner mold.

The two pieces of inner mold were separated and the model removed.

### Making a Moldable Composition

A homogeneous moldable composition was made by mixing a desired amount of beach sand (e.g., harvested from the Banana Beach in Tel Aviv, Israel) with an appropriate amount of waterglass, 100 parts beach sand to between 3 and 10 parts of waterglass.

### Carbon Dioxide Dispenser

A proximal end of a 1 meter long rubber tube was placed snugly over the gas outlet needle of a commercialy carbon dioxide dispenser (by SodaStream International Ltd., Airport City, Israel). A hypodermic needle was placed inside the distal end of the rubber tube. The tube was secured to the outlet needle and the hypdermic needle using cable ties.

### Molding an Object

Moldable composition described above was placed and tamped in both pieces of the inner mold. Excess composition was scraped away so that the layer of composition in both mold pieces was flush with the mold-piece peripheral faces. The first mold piece with moldable composition was placed on the ground with composition upwards. The second mold piece with moldable composition was placed moldable composition down on the first mold piece.

The distal end of the hypodermic needle of the carbon dioxide dispenser was either placed in the mold cavity by pushing the needle through the gap between the two mold pieces or by pushing through the silicone walls of one of the mold cavities.

The carbon dioxide dispenser was activated in the usual way (opening a valve) for a period of around 30 seconds so that carbon dioxide from the dispenser entirely displaced air found in the mold cavity and througout the moldable composition.

The two mold pieces were separated and a completely solid object, a stylized cat doll, was retrieved.

### Sculpting an Object

Moldable composition as described above was used to make a sand castle in the usual way with the usual tools, e.g., a crenellated plastic bucket When the sand castle was completed, the distal end of the hypodermic needle of the carbon dioxide dispenser was inserted into a portion of the sand castle and the carbon dioxide dispenser activated in the usual way for a period of around 30 seconds. The sand composition in the vicinity of the needle soldified. The insertion of the needle was repeated a number of times at different locations in the sand castle until the entire sand castle was a single solid object.

### Durability of an Object

Objects made from composition having less than 3 parts waterglass to 100 parts beach sand were not cohesive and disintegrated on touch.

Starting from 3 parts waterglass to 100 parts beach sand, made objects became increasingly hard, durable and resistant to breaking.

Objects made from composition having 10 parts or more waterglass to 100 parts beach sand were very hard and durable.

When maintained dry and without touching, objects having at least 3 parts watergalss to 100 parts sand seemed to have unlimited durability.

Objects the size of the cat described above started noticeably disintegrating after 3 hours immersion in tap water and 6 hours immersion in salt (Mediterranean Sea) water.

Objects the size of the cat did not noticeably disintegrate for at least three hours with intermittent immersion in salt water when actively played with by 4-year old children.

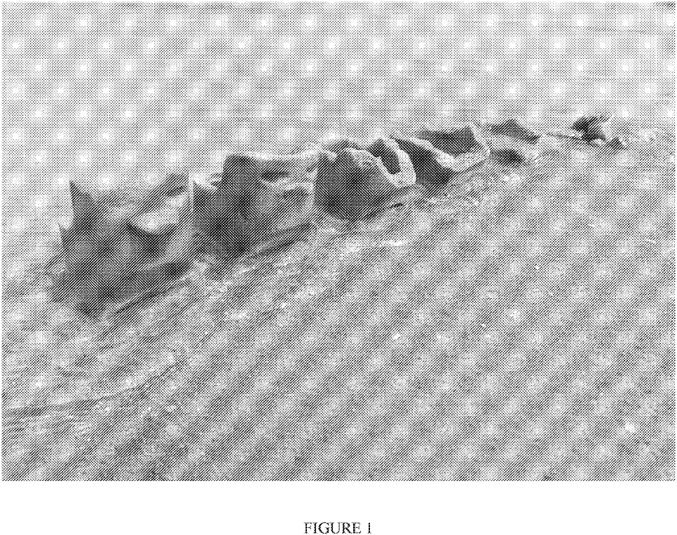

FIG. 1 is a reproduction of a photograph demonstrating the durability and stages of enviromentally-friendly disintegration of objects in accordance with the teachings herein. Specifically, six identical stylized cats were made in accordance with the teachings herein, using a two-part silicone mold and 6 parts of waterglass to 100 parts sand harvested from the Banana Beach, Tel Aviv, Israel. The objects were placed on the shoreline of the beach, were continuously soaked with Mediterranean Sea water and either beaten by the action of waves or played with by children, From left to right: first object, after 20 minutes; second object after 40 minutes; third object after 60 minutes; fourth object after 80 minutes, fifth object after 100 minutes; and sixth and last object, after 120 minutes.

Unless otherwise defined, all technical and scientific terms used herein have the same meaning as commonly understood by one of ordinary skill in the art to which the invention pertains. In case of conflict, the specification, including definitions, takes precedence.

As used herein, the terms “comprising”, “including”, “having” and grammatical variants thereof are to be taken as specifying the stated features, integers, steps or components but do not preclude the addition of one or more additional features, integers, steps, components or groups thereof.

As used herein, the indefinite articles “a” and “an” mean “at least one” or “one or more” unless the context clearly dictates otherwise

As used herein, when a numerical value is preceded by the term “about”, the term “about” is intended to indicate +/-10%.

As used herein, a phrase in the form “A and/or B” means a selection from the group consisting of (A), (B) or (A and B). As used herein, a phrase in the form “at least one of A, B and C” means a selection from the group consisting of (A), (B), (C), (A and B), (A and C), (B and C) or (A and B and C).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. An object made of waterglass-bonded sand, the object being a final goods selected from the group consisting of a toy, a medallion, a building block, furniture and a wall.

2. The object of claim 1, comprising not less than 50% by weight said waterglass-bonded sand.

3. The object of claim 1, wherein sand in said waterglass-bonded sand is beach sand.

4. The object of claim 1, being a toy.

5. The object of claim 4, weighing not more than 1000 g.

6. The object of claim 4, the object being a toy selected from the group consisting of a human figure, an animal figure, a vehicle figure, a container, a digging implement, and a toy building block.

7. The object of claim 1, the object being a medallion weighing not more than 400 g.

8. The object of claim 1, the object being a building block.

9. The object of claim 8, the object being a building block selected from the group consisting of a brick, a block, a building frame, a shingle, and a roofing tile.

10. The object of claim 1, the object being furniture.

11. The object of claim 10, the object being furniture selected from the group consisting of a beach chair, a bench, a lounger, a stool, a table and a bar.

12. The object of claim 1, being a scented object.

13. A method for making an object, comprising:
a. providing a moldable composition including a combination of sand and waterglass;
b. fashioning said moldable composition into the shape of an object being a final goods selected from the group consisting of a toy, a medallion, a building block, furniture and a wall; and
c. contacting said shaped moldable composition with an amount of weak acid for a duration sufficient to change said shaped moldable composition to waterglass-bonded sand having the shape of said object,
thereby making the object.

14. The method of claim 13, wherein said providing includes:
harvesting sand from a beach; and
combining said harvested sand with waterglass, and optionally with at least one additional material,
thereby providing said moldable composition.

15. The method of claim 13, wherein said combining said harvested sand with said waterglass is performed at said beach.

16. The method of claim 13, wherein at least one of:
said fashioning said moldable composition into the shape of an object is performed at
said beach; and said contacting said shaped moldable composition with an amount of weak acid is performed at said beach.

17. The method of claim 13, wherein said sand is unrinsed sand.

18. The method of claim 13, wherein said contacting a weak acid with said shaped moldable composition comprises contacting gaseous CO₂ with said shaped moldable composition which comprises at least one method selected from the group consisting of:
injecting gaseous carbon dioxide into said shaped moldable composition from a carbon dioxide reservoir;
immersing said shaped moldable composition in a carbon dioxide-enriched atmosphere;
applying gaseous carbon dioxide to said shaped moldable composition from the top thereof; and
placing dry ice on said shaped moldable composition.

19. The method of claim 13, further comprising adding a scent material to said moldable composition, to said shaped moldable composition and/or to said waterglass-bonded sand, so that the object is a scented object.

20. A kit for making an object, comprising:
a waterglass in a container;
a carbon dioxide dispenser that includes:
a hollow injection needle having a distal end that is to be configured to be inserted into a mass of a composition comprising glass and watersand allowing dispensing of carbon dioxide into the mass of composition; and
a controllable dispensing valve that allows release of carbon dioxide from a carbon dioxide reservoir physically associated with the dispensing valve and out of the hollow injection needle.
